(19) United States
(12) Patent Application Publication
(10) Pub. No.: US 2026/0253073 A1
(43) Pub. Date: Aug. 27, 2026

(54) BLOCKCHAIN-BASED INTEGRATED SYSTEM FOR TRAVEL PRODUCTS AND SERVICES

(71) Applicant: TravelXchange Inc., Miami, FL (US)

(72) Inventors: Juan Pablo LAFOSSE, Buenos Aires (AR); Facundo DIAZ, Buenos Aires (AR)

(21) Appl. No.: 18/994,276

(22) PCT Filed: Jul. 14, 2023
(86) PCT No.: PCT/US2023/027820

§ 371 Date: Jan. 14, 2025

Related U.S. Application Data
(60) Provisional application No. 63/368,379, filed on Jul. 14, 2022.
(60) Provisional application No. 63/368,384, filed on Jul. 14, 2022.
(60) Provisional application No. 63/368,386, filed on Jul. 14, 2022.
(60) Provisional application No. 63/368,388, filed on Jul. 14, 2022.

(51) Int. Cl. G06Q 20/40; G06Q 10/087; G06Q 20/12; H04L 9/00; H04L 9/32

(52) U.S. Cl. CPC G06Q 20/401; G06Q 10/0877; G06Q 20/123; G06Q 20/405; H04L 9/3236; H04L 9/50

(57) ABSTRACT

The disclosed technology includes a blockchain-based technique for generating a non-fungible digital asset based on a code that represents a travel service product. The code is stored in a travel service database in association with a user information and the non-fungible digital asset is also associated with the user information. The code stored in the travel service database coexists with the linked non-fungible digital asset stored at a blockchain. The technique further includes successively performing transactions with the non-fungible digital asset through additional users to a final user, detecting expiration for utilizing the underlying travel service product and, in response, fixing the association of the code to the final user and preventing further transactions with the non-fungible digital asset.

### CROSS-REFERENCE TO RELATED APPLICATIONS

This application claims priority to and the benefits of U.S. Provisional Application No. 63/368,379 entitled “PROOF OF INVENTORY BLOCKCHAIN CONSENSUS PROTOCOL FOR TRAVEL INDUSTRY” filed on Jul. 14, 2022, U.S. Provisional Application No. 63/368,384 entitled “APPLICATION PROGRAMMING INTERFACE (API) FOR NON-FUNGIBLE DIGITAL ASSETS IN BLOCKCHAIN-BASED INFRASTRUCTURE FOR TRAVEL INDUSTRY” filed on Jul. 14, 2022, U.S. Provisional Application No. 63/368,388 entitled “DIGITAL ASSET ALLOCATION SYSTEM FOR TRAVEL INDUSTRY” filed on Jul. 14, 2022, and U.S. Provisional Application No. 63/368,386 entitled “SMART CONTRACTS FOR TRAVEL PRODUCTS” filed on Jul. 14, 2022. The entire disclosures of the aforementioned applications are herein incorporated by reference as part of the disclosure of this application.

### BACKGROUND

Information-based technology has had a significant and considerable impact on the travel industry. Computer systems and the Internet allow for constant communication between branches and locations of travel service providers, which makes it easy to monitor and streamline reservations and adhere to industry policies. Information-based technology is also used internally such that staff can be informed of any new developments and are kept on the same page.

Further, enterprise-level software enables travel service companies to manage their services effectively and process data in a structured and organized manner. Further, improved communications technology has greatly widened the ways in which travel service companies can communicate. Data can be sent almost instantly to an airline from an agency, which can then be relayed to customers to ensure quick bookings. This allows travel service agencies to run more productively, preventing losses due to slow running loading times and other arduous tasks.

### BRIEF DESCRIPTION OF THE DRAWINGS

Detailed descriptions of implementations of the present invention will be described and explained through the use of the accompanying drawings.

FIG. 1 is a block diagram illustrating an example structure including a portion of a blockchain.

FIG. 2A is a drawing illustrating an example hash algorithm.

FIG. 2B is a drawing illustrating an example cryptographic wallet.

FIG. 3 is a block diagram illustrating an example machine learning (ML) system.

FIG. 4 illustrates a process including smart contracts to allocate non-fungible digital assets that represent travel service products.

FIG. 5 illustrates components of a platform for exchanging non-fungible digital assets that represent travel service products.

FIG. 6 illustrates a system including a blockchain-based exchange of non-fungible digital assets that represent travel service products.

FIG. 7A illustrates functional components of a proof of inventory blockchain consensus protocol.

FIG. 7B illustrates functional components of an application programming interface for non-fungible digital assets that represent travel service products.

FIG. 7C illustrates a system that tokenizes travel service products to enable resale, transfer, and trading of the travel products using corresponding non-fungible digital assets.

FIG. 7D illustrates functional components of a platform for exchanging non-fungible digital assets that represent travel service products.

FIG. 8 is a flowchart that illustrates processes performed by a blockchain-based platform for travel service products.

FIG. 9 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present disclosure introduces a technology specifically tailored for the travel industry, featuring a proof of inventory system that harnesses the capabilities of blockchain. This system revolutionizes how travel industry suppliers manage their inventory and offer their services. It achieves this by integrating and validating the airline's inventory, conditions, and prices through seamless integration processes. The system then associates this information with a smart contract generated on a blockchain network. The smart contract acts as a non-fungible token (NFT), ensuring the authenticity and immutability of the inventory data. By implementing this advanced system, airlines can seamlessly connect with blockchain-based distribution channels and extend their reach to a diverse range of customer segments. This integration process maintains a continuous and up-to-date synchronization between the airline's internal systems and the smart contract, providing a reliable and efficient solution for inventory management within the travel industry.

In another aspect, the disclosed system encompasses a unique application programming interface (API) development within the blockchain-based technology framework, specifically designed for travel industry suppliers. This API blockchain-based infrastructure seamlessly integrates cryptographic technology, distributed ledger technology (e.g., blockchain), and traditional inventory management systems commonly used by airlines, as well as other intermediary systems like Passenger Service Systems (PSS) or Global Distribution Systems (GDS). By connecting their inventory through APIs with this intermediary infrastructure, airlines, travel suppliers, and developers gain access to offer travel assets as non-fungible digital assets. This innovative infrastructure opens up new avenues for distributing travel products and services, expanding the customer base, and creating unprecedented opportunities for the travel industry to embrace secure and efficient inventory management practices.

In another aspect, the disclosed system utilizes blockchain technology to introduce tools and capabilities in the travel industry, which has long relied on outdated processes and technologies. By leveraging smart contracts, the disclosed system empowers passengers to become true owners of their travel products, managing them securely within a cryptographically secure wallet. This unprecedented level of ownership enables passengers to have full control and flexibility over their travel assets, facilitating seamless management and providing a frictionless experience when it comes to tasks such as canceling or modifying flight reservations. With all relevant conditions embedded within the smart contract, passengers have complete visibility and transparency, ensuring clarity and eliminating uncertainties in retailing and managing travel products. The integration of smart contracts not only enhances the agility and independence of passengers in managing their travel assets but also revolutionizes the way travel products are retailed and managed, ushering in a new era of transparency and efficiency in the travel industry.

In another aspect, the disclosed system revolutionizes the representation of airline products, travel suppliers, and related offerings as non-fungible digital assets, such as NFTs. By securely storing all pertinent information and transactional details within the non-fungible token smart contract, the system simplifies distribution processes and opens up new possibilities for various actors in the industry. With the stamped and fully tracked nature of the smart contract, seamless integration with social media platforms and other distribution channels becomes possible, enabling secure, efficient, and automatic peer-to-peer transactions. This creates a paradigm shift by reshaping the limited distribution landscape and offering simplified processes for airlines. Additionally, it paves the way for existing and new industry players to enhance distribution capabilities and explore new use cases. For example, financial solutions and innovative integrations can be built on top of the system, leveraging the transparent and secure management of air tickets. This introduces a new era of distribution, empowering stakeholders to reimagine the possibilities and reshape the industry's distribution landscape to better serve customers and drive overall growth.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Blockchain and Non-Fungible Digital Assets

The advantages and benefits of the methods, systems, and apparatuses disclosed herein include the reduction of security vulnerabilities with respect to both travel-industry devices as well as network systems when compared to traditional methods. The disclosed methods improve fidelity of data transferred, authentication of users attempting to access the sensitive data (e.g., personal data and ticket data), and/or the like. For example, the methods may be used to ascertain that data being transmitted and received is correct and not tampered with. Similarly, the methods may be used to ensure that sensitive information is only being shared with appropriate authorized users (e.g., airline agencies) and shared by the correct party.

The disclosed systems can prevent security failures that can occur due to human error when compared to traditional systems. In addition, the advantages of the convolutional neural network (CNN) used for machine learning (ML) in disclosed examples include the preclusion of feature extraction and the use of shared weight in convolutional layers, which means that the same filter (weights bank) is used for each node in the layer; this both reduces memory footprint and improves performance.

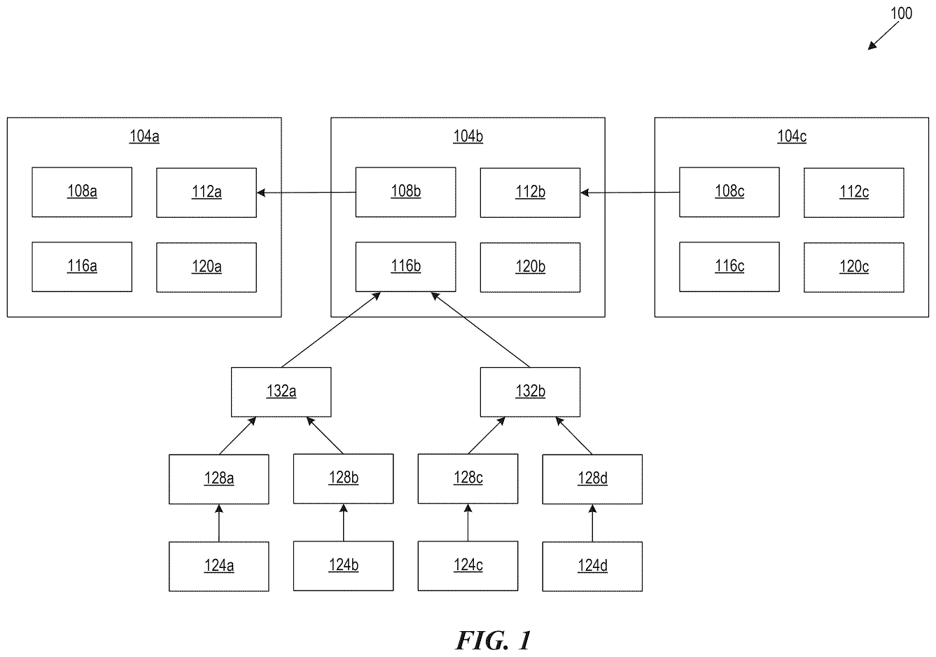

FIG. 1 is a block diagram illustrating a portion of an example blockchain system 100. Blockchain system 100 includes blockchain 100. In embodiments, the blockchain 104 is a distributed ledger of transactions (e.g., a continuously growing list of records, such as records of transactions for digital assets such as cryptocurrency, bitcoin, or electronic cash) that is maintained by a blockchain system 100. For example, the blockchain 104 is stored redundantly at multiple nodes (e.g., computers) of a blockchain network. Each node in the blockchain network can store a complete replica of the entire blockchain 104. In some embodiments, the blockchain system 100 implements storage of an identical blockchain at each node, even when nodes receive transactions in different orderings. The blockchain 104 shown by FIG. 1 includes blocks 104a, 104b, 104c. Likewise, embodiments of the blockchain system 100 can include different and/or additional components or be connected in different ways.

The terms “blockchain” and “chain” are used interchangeably herein. In embodiments, the blockchain 104 is a distributed database that is shared among the nodes of a computer network. As a database, the blockchain 104 stores information electronically in a digital format. The blockchain 104 can maintain a secure and decentralized record of transactions (e.g., transactions 124a, 124b). For example, the ERC-721 or ERC-1155 standards are used for maintaining a secure and decentralized record of transactions. The blockchain 104 provides fidelity and security for the data record. In embodiments, blockchain 104 collects information together in groups, known as “blocks” (e.g., blocks 104a, 104b) that hold sets of information.

The blockchain 104 structures its data into chunks (blocks) (e.g., blocks 104a, 104b) that are strung together. Blocks (e.g., block 104c) have certain storage capacities and, when filled, are closed and linked to a previously filled block (e.g., block 104b), forming a chain of data known as the “blockchain.” New information that follows a freshly added block (e.g., block 104b) is compiled into a newly formed block (e.g., block 104c) that will then also be added to the blockchain 104 once filled. The data structure inherently makes an irreversible timeline of data when implemented in a decentralized nature. When a block is filled, it becomes a part of this timeline of blocks. Each block (e.g., block 104a) in the chain 100 is given an exact timestamp (e.g., timestamp 112a) when it is added to the chain 100. In the example of FIG. 1, blockchain 100 includes multiple blocks 104a-c. Each of the blocks 104a-c can represent one or multiple transactions and can include a cryptographic hash of the previous block (e.g., previous hashes 108a-c), a timestamp (e.g., timestamps 112a-c), a transactions root hash (e.g., 116a-c), and a nonce (e.g., 120a-c). A transactions root hash (e.g., transactions root hash 116b) indicates the proof that the block 104b contains all the transactions in the proper order. The transactions root hash 116b proves the integrity of transactions in the block 104b without presenting all transactions.

In embodiments, the timestamp 112a-c of each of corresponding blocks 104a-c includes data indicating a time associated with the block. In some examples, the timestamp includes a sequence of characters that uniquely identifies a given point in time. In one example, the timestamp of a block includes the previous timestamp in its hash and enables the sequence of block generation to be verified.

In embodiments, nonces 120a-c of each of corresponding blocks 104a-c include any generated random or semi-random number. The nonce can be used by miners during proof of work (PoW), which refers to a form of adding new blocks of transactions to blockchain 104. The work refers to generating a hash that matches the target hash for the current block. For example, a nonce is an arbitrary number that miners (e.g., devices that validate blocks) can change in order to modify a header hash and produce a hash that is less than or equal to the target hash value set by the network.

As described above, each of blocks 104a, 104b, 104c of exemplary blockchain 104 can include respective block hash 116a, 116b, 116c. Each of block hashes 116a-c can represent a hash of a root node of a Merkle tree for the contents of the block (e.g., the transactions of the corresponding block). For example, the Merkle tree contains leaf nodes corresponding to hashes of components of the transaction, such as a reference that identifies an output of a prior transaction that is input to the transaction, an attachment, and a command. Each non-leaf node can contain a hash of the hashes of its child nodes. The Merkle tree can also be considered to have each component as the leaf node with its parent node corresponding to the hash of the component.

In the example of FIG. 1, block 104b records transactions 124a-d. Each of the leaf nodes 128a-d contain a hash corresponding to transactions 124a-d respectively. As described above, a hash (e.g., the hash in leaf node 128a) can be a hash of components of a transaction (e.g., transaction 124a), for example, a reference that identifies an output of a prior transaction that is input to the transaction 124a, an attachment, and a command. Each of the non-leaf nodes 132a, 132b can contain a hash of the hashes of its child nodes (e.g., leaf nodes 12ba-b). In this example, node 132a can contain a hash of the hashes contained in 128a, 128b and node 132b can contain a hash of the hashes contained in 128c, 128d. The root node 116b can contain a hash of the hashes of child nodes 132a-b.

A Merkle tree representation of a transaction (e.g., 124a) allows an entity needing access to the transaction 124a to be provided with only a portion that includes the components that the entity needs. For example, if an entity needs only the transaction summary, the entity can be provided with the nodes (and each node's sibling nodes) along the path from the root node to the node of the hash of the transaction summary. The entity can confirm that the transaction summary is that used in the transaction124a by generating a hash of the transaction summary and calculating the hashes of the nodes along the path to the root node. If the calculated hash of the root node matches the hash 128a of the transaction 124a, the transaction summary is confirmed as the one used in the transaction. Because only the portion of the Merkle tree relating to components that an entity needs is provided, the entity will not have access to other components. Thus, the confidentiality of the other components is not compromised.

In some examples, the blockchain 100 is a bitcoin system developed to allow digital assets such as electronic cash to be transferred directly from one party to another without going through a central authority, such as financial institution (e.g., as described in the white paper entitled “Bitcoin: A Peer-to-Peer Electronic Cash System” by Satoshi Nakamoto, hereby incorporated by reference in its entirety). A bitcoin (an electronic coin) can be represented by a chain of transactions that transfers ownership from one party to another party.

To transfer ownership of a digital asset, such as a bitcoin, using the blockchain 100, a new transaction, such as one of transactions 124a-d, is generated and added to a stack of transactions in a block, e.g., block 104b. To record a transaction in a blockchain, each party and asset involved with the transaction needs an account that is identified by a digital token. For example, when a first user wants to transfer an asset that the first user owns to a second user, the first and second user both create accounts, and the first user also creates an account that is uniquely identified by the asset's identification number. The account for the asset identifies the first user as being the current owner of the asset. The first user (i.e., the current owner) creates a transaction (e.g., 124a) against the account for the asset that indicates that the transaction 124a is a transfer of ownership and outputs a token identifying the second user as the next owner and a token identifying the asset. The transaction 124a is signed by the private key of the first user (i.e., the current owner), and the transaction 124a is evidence that the second user is now the new current owner and that ownership has been transferred from the first to the second user.

The new transaction 124a, which includes the public key of the new owner (e.g., a second user to whom a digital asset is assigned ownership in the transaction), is digitally signed by the first user with the first user's private key to transfer ownership to the second user (e.g., new owner), as represented by the second user public key. The signing by the owner of the bitcoin is an authorization by the owner to transfer ownership of the bitcoin to the new owner via the new transaction 124a. Once the block is full, the block is “capped” with a block header, that is, a hash digest of all the transaction identifiers within the block. The block header is recorded as the first transaction in the next block in the chain, creating a mathematical hierarchy called the “blockchain.” To verify the current owner, the blockchain 104 of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

Additionally, in some embodiments, the blockchain 100 uses one or more smart contracts to enable more complex transactions. A smart contract includes computer code implementing transactions of a contract. The computer code can be executed on a secure platform (e.g., an Ethereum platform, which provides a virtual machine) that supports recording transactions (e.g., 124a-d) in blockchains. For example, a smart contract can be a self-executing contract with the terms of the agreement between buyer and seller being directly written into lines of code. The code and the agreements contained therein exist across a distributed, decentralized blockchain network.

In addition, the smart contract can itself be recorded as a transaction 124a in the blockchain 104 using a token that is a hash 128a of the computer code so that the computer code that is executed can be authenticated. When deployed, a constructor of the smart contract executes, initializing the smart contract and its state. The state of a smart contract is stored persistently in the blockchain 104. When a transaction 124a is recorded against a smart contract, a message is sent to the smart contract, and the computer code of the smart contract executes to implement the transaction (e.g., debit a certain amount from the balance of an account). The computer code ensures that all the terms of the contract are complied with before the transaction 124a is recorded in the blockchain 104.

For example, a smart contract can support the sale of an asset. The inputs to a smart contract to sell an asset can be tokens identifying the seller, the buyer, the asset, and the sale price in U.S. dollars or cryptocurrency. The computer code is used to ensure that the seller is the current owner of the asset and that the buyer has sufficient funds in their account. The computer code records a transaction (e.g., 124a) that transfers the ownership of the asset to the buyer and a transaction (e.g., 124b) that transfers the sale price from the buyer's account to the seller's account. If the seller's account is in U.S. dollars and the buyer's account is in Canadian dollars, the computer code can retrieve a currency exchange rate, determine how many Canadian dollars the seller's account should be debited, and record the exchange rate. If either transaction 124a, 124b is not successful, neither transaction is recorded.

When a message is sent to a smart contract to record a transaction 124a, the message is sent to each node that maintains a replica of the blockchain 104. Each node executes the computer code of the smart contract to implement the transaction 124a. For example, if a hundred nodes each maintain a replica of the blockchain 104, the computer code executes at each of the hundred nodes. When a node completes execution of the computer code, the result of the transaction 124a is recorded in the blockchain 104. The nodes employ a consensus algorithm to decide which transactions (e.g., 124c) to keep and which transactions (e.g., 124d) to discard. Although the execution of the computer code at each node helps ensure the authenticity of the blockchain 104, large amounts of computer resources are required to support such redundant execution of computer code.

Although blockchains can effectively store transactions 124a-d, the large amount of computer resources, such as storage and computational power, needed to maintain all the replicas of the blockchain can be problematic. To overcome this problem, some systems for storing transactions 124a-d do not use blockchains, but rather have each party to a transaction maintain its own copy of the transaction 124a. One such system is the Corda™ system developed by R3™ that provides a decentralized distributed ledger platform in which each participant in the platform has a node (e.g., computer system) that maintains its portion of the distributed ledger.

When parties agree on the terms of a transaction 124a, a party submits the transaction 124a to a notary, which is a trusted node, for notarization. The notary maintains a consumed output database of transaction outputs that have been input into other transactions. When a transaction 124a is received, the notary checks the inputs to the transaction 124a against the consumed output database to ensure that the outputs that the inputs reference have not been spent. If the inputs have not been spent, the notary updates the consumed output database to indicate that the referenced outputs have been spent, notarizes the transaction 124a (e.g., by signing the transaction or a transaction identifier with a private key of the notary), and sends the notarized transaction to the party that submitted the transaction 124a for notarization. When the party receives the notarized transaction, the party stores the notarized transaction and provides the notarized transaction to the counterparties.

In embodiments, a notary is a non-validating notary or a validating notary. When a non-validating notary is to notarize a transaction (e.g., 124b), the non-validating notary determines that the prior output of a prior transaction (e.g., 124a), that is, the input of the current transaction 124b, has not been consumed. If the prior output has not been consumed, the non-validating notary notarizes the transaction 124b by signing a hash 128b of the transaction. To notarize a transaction 124b, a non-validating notary needs only the identification of the prior output (e.g., the hash 128a of the prior transaction 124a and the index of the output) and the portion of the Merkle tree needed to calculate the hash 128b of the transaction 124b.

As described herein, in some embodiments, the blockchain 100 uses one or more smart contracts to enable more complex transactions. For example, a validating notary validates a transaction (e.g., 124d), which includes verifying that prior transactions 124a-c in a backchain of transactions are valid. The backchain refers to the collection of prior transactions (e.g., 124c) of a transaction 124d, as well as prior transactions 124a-b of those prior transactions 124c, and so on. To validate a transaction 124d, a validating notary invokes validation code of the transaction 124d. In one example, a validating notary invokes validation code of a smart contract of the transaction 124d. The validation code performs whatever checks are needed to comply with the terms applicable to the transaction 124d. This checking may include retrieving the public key of the owner from the prior transaction 124c (pointed to by the input state of the transaction 124d) and checks the signature of the transaction 124d, ensuring that the prior output of a prior transaction that is input has not been consumed, and checking the validity of each transaction (e.g., 124c) in the backchain of the transactions. If the validation code indicates that the transaction 124d is valid, the validating notary notarizes the transaction 124d and records the output of the prior transaction 124c as consumed.

In some examples, to verify that the transactions 124a-d in a ledger stored at a node are correct, the blocks 104a-c in the blockchain 104 can be accessed from oldest 104a to newest 104c, generating a new hash of the block 104c and comparing the new hash to the hash 108c generated when the block 104c was created. If the hashes are the same, then the transactions in the block are verified. In one example, the Bitcoin system also implements techniques to ensure that it would be infeasible to change a transaction 124a and regenerate the blockchain 104 by employing a computationally expensive technique to generate a nonce 120b that is added to the block when it is created. A bitcoin ledger is sometimes referred to as an Unspent Transaction Output (“UTXO”) set because it tracks the output of all transactions that have not yet been spent.

In some embodiments, a self-sovereign identity (SSI) approach to digital identity is used that gives individuals control over the information they use to prove who they are to websites, services, and applications across the web. In an SSI system, the user accesses services in a streamlined and secure manner, while maintaining control over the information associated with their identity. SSI addresses the difficulty of establishing trust in an interaction. In order to be trusted, one party in an interaction will present credentials to the other parties, and those relying on parties can verify that the credentials came from an issuer that they trust. In this way, the verifier's trust in the issuer is transferred to the credential holder. This basic structure of SSI with three participants is sometimes called “the trust triangle”. For an identity system to be self-sovereign, users control the verifiable credentials that they hold and their consent is required to use those credentials. This reduces the unintended sharing of users' personal data.

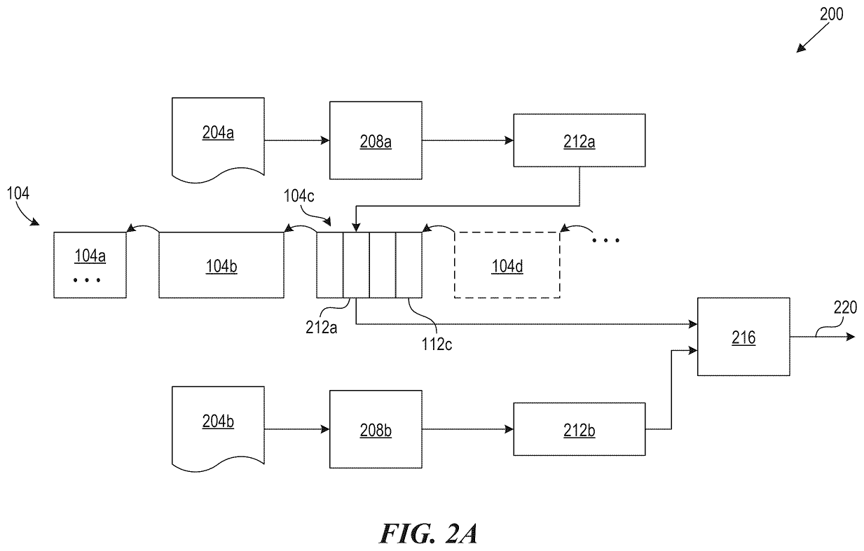

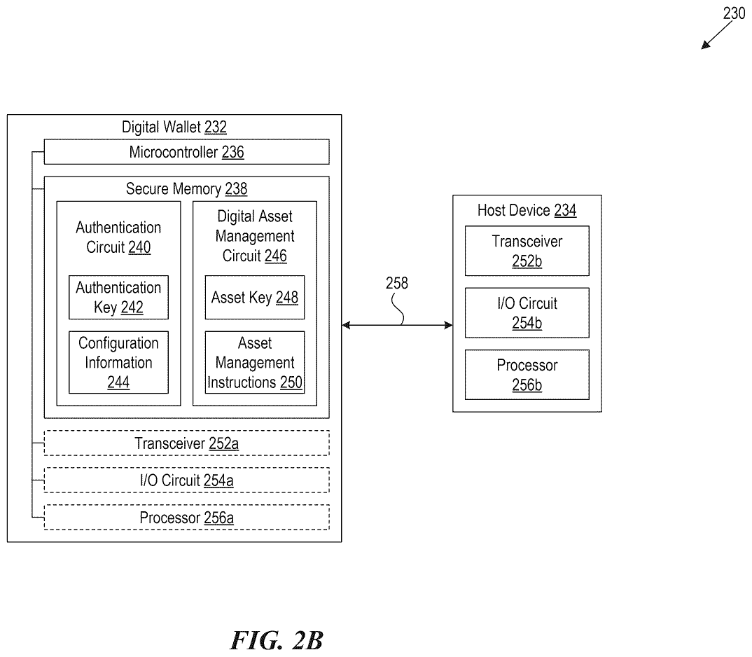

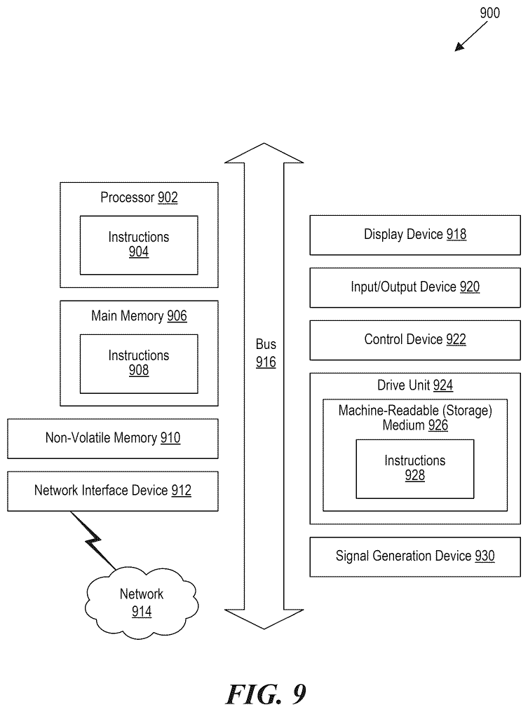

FIG. 2A illustrates a process 200 that uses a hash algorithm to generate an NFT or perform a cryptographic transaction on a blockchain. An exemplary blockchain 104, e.g., as shown in FIG. 2A, is also illustrated and described in detail with reference to FIG. 1. The process 200 can be performed by a computer system such as that described with reference to FIG. 9 and/or by nodes of the blockchain 104. Some embodiments include different and/or additional steps or perform steps in different orders.

In embodiments, a digital message, electronic art, a digital collectible, any other form of digital content, or a combination thereof 204a may be hashed using hashing algorithm 208a. The hashing algorithm 208a (sometimes referred to as a “hash function”) may be a function used to map data of arbitrary size (e.g., content 204a) to fixed-size values (e.g., hash 212a). The values 212a that are returned by the hash function 208a can be called hash values, hash codes, digests, or hashes. The values 212a can be used to index a fixed-size table called a hash table. A hash table, also known as a hash map, is a data structure that implements an associative array or dictionary, which is an abstract data type that maps keys (e.g., content 204a) to values 212a.

The output of the hashed content 204a (e.g., hash 212a) can be inserted into a block (e.g., block 104c) of the blockchain 104 (e.g., comprising blocks such as blocks 104a-d). The block 104c can include, among other things, information such as timestamp 112c. In order to verify that the block 104c is correct, a new hash 212b is generated by applying hashing algorithm 208b to the digital content 204b. The new hash 212b is compared to the hash 212a in the blockchain 104 at comparison step 216. If the new hash 212b is the same as the hash 212a of the block 104c, the comparison yields an indication that they match. For example, the decision 220 can indicate that the hashes 212a-b are the same or not. The hashes can be indicated to be the same if the characters of the hash match. The hashing algorithms 208a-b can include any suitable hashing algorithm. Examples include Message Digest 5 (MD5), Secure Hashing Algorithm (SHA) and/or the likes.

Components of the process 200 can generate or validate an NFT, which is a cryptographic asset that has a unique identification code and metadata that uniquely identifies the NFT. In one example, the digital content 204a can be hashed and minted to generate an NFT, or the content 204a can represent an NFT that is verified using the process 200 and the content 204b. An NFT can include digital data (e.g., 212a) stored in the blockchain 104. The ownership of an NFT (e.g., 212a) is recorded in the blockchain 104 and transferrable by an owner, allowing the NFT 212a to be sold and traded. The NFT 212a contains a reference to digital files such as photos, videos, or audio (e.g., content 204a). Because NFTs are uniquely identifiable assets, they differ from cryptocurrencies, which are fungible. In particular, NFTs function like cryptographic tokens, but unlike cryptocurrencies such as Bitcoin or Ethereum™, NFTs are not mutually interchangeable, and so are not fungible.

The NFT can be associated with a particular digital or physical asset such as images, art, music, and sport highlights (e.g., content 104a) and can confer licensing rights to use the asset 104a for a specified purpose. As with other assets, NFTs are recorded on a blockchain when a blockchain 104 concatenates records containing cryptographic hashes—sets of characters that identify a set of data—onto previous records, creating a chain of identifiable data blocks 104a-d. A cryptographic transaction process enables authentication of each digital file by providing a digital signature that tracks NFT ownership. In embodiments, a data link that is part of the NFT records points to details about where the associated art (content 104a) is stored.

Minting an NFT (e.g., 212a) may refer to the process of turning a digital file (e.g., 204a) into a crypto collectible or digital asset 212a on blockchain 104 (e.g., the Ethereum™ blockchain). The digital item or file 204a may be stored in the blockchain 104 and may not be able to be edited, modified, or deleted. The process of uploading a specific item onto the blockchain 104 is known as “minting.” For example, “NFT minting” can refer to a process by which a digital art or digital content 204a becomes a part of the Ethereum™ blockchain. Thus, the process turns digital content 204a into a crypto asset 212a, which is easily traded or bought with cryptocurrencies on a digital marketplace without an intermediary.

FIG. 2B is a block diagram 230 illustrating an example digital wallet device. In particular, a digital wallet 232 is an electronic entity that allows users to securely manage digital assets. According to various embodiments, the digital wallet 332 can be a hardware-based wallet (e.g., can include dedicated hardware component(s)), a software-based wallet, or a combination thereof. Example digital assets that can be stored and managed using the digital wallet 232 include digital coins, digital tokens, and/or the like. In some embodiments, tokens are stored on a blockchain system, such as the blockchain system 100 described in FIG. 1. In some embodiments, the digital wallet 232 may be capable of connecting to and managing digital assets that are native to or associated with different blockchain systems 100.

As defined herein, the terms “coin” and “token” refer to a digital representation of a particular asset, utility, ownership interest, and/or access right. Any suitable type of coin or token can be managed using various embodiments of the digital wallet 232. In some embodiments, tokens include cryptocurrency, such as exchange tokens and/or stable coins. Exchange tokens and/or stable coins can be native to a particular blockchain system 100 and, in some instances, can be backed by a value-stable asset, such as fiat currency, precious metal, oil, or another commodity. In some embodiments, tokens are utility tokens that provide access to a product or service rendered by an operator of the blockchain system 100 (e.g., a token issuer). In some embodiments, tokens are security tokens, which can be securitized cryptocurrencies that derive from a particular asset, such as bonds, stocks, real estate, and/or fiat currency, or a combination thereof, and can represent an ownership right in an asset or in a combination of assets.

In some embodiments, tokens are NFTs or other non-fungible digital certificates of ownership, or decentralized finance (DeFi) tokens. DeFi tokens can be used to access feature sets of DeFi software applications (dApps) built on the blockchain system 100. Example dApps can include decentralized lending applications (e.g., Aave), decentralized cryptocurrency exchanges (e.g., Uniswap), decentralized NFT marketplaces (e.g., OpenSea, Rarible), decentralized gaming platforms (e.g., Upland), decentralized social media platforms (e.g., Steemit), decentralized music streaming platforms (e.g., Audius), and/or the like. In some embodiments, tokens provide access rights to various computing systems and can include authorization keys, authentication keys, passwords, PINs, biometric information, access keys, and other similar information. The computing systems to which the tokens provide access can be both on-chain (e.g., implemented as dApps on a particular blockchain system 100) or off-chain (e.g., implemented as computer software on computing devices that are separate from the blockchain system 100).

The digital wallet 232 can be embodied in a device that is communicatively coupled to the host device 234 (e.g., a mobile phone, a laptop, a tablet, a desktop computer, a wearable device, a point-of-sale (POS) terminal, an automated teller machine (ATM) and the like) via the communication link 258. In some embodiments, the host device 234 can extend the feature set available to the user of the digital wallet 232 when it is coupled to the host device 234. For instance, the host device 234 may provide the user with the ability to perform balance inquiries, convert tokens, access exchanges and/or marketplaces, perform transactions, access computing systems, and/or the like.

In some embodiments, the digital wallet 232 and the host device 234 can be owned and/or operated by the same entity, user, or a group of users. For example, an individual owner of the digital wallet 232 can also operate a personal computing device that acts as a host device 234 and provides enhanced user experience relative to the digital wallet 232 (e.g., by providing a user interface that includes graphical features, immersive reality experience, virtual reality experience, or similar). In some embodiments, the digital wallet 232 and the host device 234 can be owned and/or operated by different entities, users and/or groups of users. For example, the host device 234 can be a point-of-sale (POS) terminal at a merchant location, and the individual owner of the digital wallet 232 can use the digital wallet 232 as a method of payment for goods or services at the merchant location by communicatively coupling the two devices for a short period of time (e.g., via chip, via near-field communications (NFC), by scanning of a bar code, by causing the digital wallet 302 to generate and display a quick response (QR) code) to transmit payment information from the digital wallet 232 to the host device 234.

The digital wallet 232 and the host device 234 can be physically separate and/or capable of being removably coupled. The ability to physically and communicatively uncouple the digital wallet 232 from the host device 234 and other devices enables the air-gapped digital wallet 232 to act as “cold” storage, where the stored digital assets are moved offline and become inaccessible to the host device 234 and other devices. Further, the ability to physically and communicatively uncouple the digital wallet 232 from the host device 234 allows the digital wallet 232 to be implemented as a larger block of physical memory, which extends the storage capacity of the digital wallet 232, similar to a safety deposit box or vault at a brick-and-mortar facility.

Accordingly, in some embodiments, the digital wallet 232 and the host device 234 are physically separate entities. In such embodiments, the communications link 258 can include a computer network. For instance, the digital wallet 232 and the host device 234 can be paired wirelessly via a short-range communications protocol (e.g., Bluetooth, ZigBee, infrared communication) or via another suitable network infrastructure. In some embodiments, the digital wallet 232 and the host device 234 are removably coupled. For instance, the host device 234 can include a physical port, outlet, opening, or similar to receive and communicatively couple to the digital wallet 232, directly or via a connector.

In some embodiments, the digital wallet 232 can include or be stored on a tangible storage media, such as a dynamic random-access memory (DRAM) stick, a memory card, a secure digital (SD) card, a flash drive, a solid state drive (SSD), a magnetic hard disk drive (HDD), or an optical disc, and/or the like and can connect to the host device via a suitable interface, such as a memory card reader, a USB port, a micro-USB port, an eSATA port, and/or the like.

In some embodiments, the digital wallet 232 can include or be stored on an integrated circuit, such as a SIM card, a smart cart, and/or the like. For instance, in some embodiments, the digital wallet 232 can be a physical smart card that includes an integrated circuit, such as a chip that can store data. In some embodiments, the digital wallet 232 is a contactless physical smart card. Advantageously, such embodiments enable data from the card to be read by a host device as a series of application protocol data units (APDUs) according to a conventional data transfer protocol between payment cards and readers (e.g., ISO/IEC 7816), which enhances interoperability between the cryptographic payment ecosystem and payment card terminals.

In some embodiments, the digital wallet 232 and the host device 234 are non-removably coupled. For instance, various components of the digital wallet 232 can be co-located with components of the host device 234 in the housing of the host device 234. In such embodiments, the host device 234 can be a mobile device, such as a phone, a wearable, or similar, and the digital wallet 232 can be built into the host device. The integration between the digital wallet 232 and the host device 234 can enable improved user experience and extend the feature set of the digital wallet 232 while preserving computing resources (e.g., by sharing the computing resources, such as transceiver, processor, and/or display or the host device 234). The integration further enables the ease of asset transfer between parties. The integration can further enhance loss protection options, as recovering a password or similar authentication information, rather than recovering a physical device, can be sufficient to restore access to digital assets stored in the digital wallet 232. In some embodiments, the non-removably coupled digital wallet 232 can be air-gapped by, for example, disconnecting the host device 234 from the Internet.

As shown, the digital wallet 232 can include a microcontroller 236. The microcontroller 236 can include or be communicatively coupled to (e.g., via a bus or similar communication pathway) at least a secure memory 238. The digital wallet 232 can further include a transceiver 252a, and input/output circuit 254a, and/or a processor 256a. In some embodiments, however, some or all of these components can be omitted.

In some embodiments, the digital wallet 232 can include a transceiver 252a and therefore can be capable of independently connecting to a network and exchanging electronic messages with other computing devices. In some embodiments, the digital wallet 232 does not include a transceiver 252a. The digital wallet 232 can be capable of connecting to or being accessible from a network, via the transceiver 252b of the host device 234, when the digital wallet 232 is docked to the host device 234. For example, in some embodiments, the user of the digital wallet 232 can participate in token exchange activities on decentralized exchanges when the digital wallet 232 is connected to the host device 234.

In some embodiments, the digital wallet 232 can include an input/output circuit 254a, which may include user-interactive controls, such as buttons, sliders, gesture-responsive controls, and/or the like. The user-interactive controls can allow a user of the digital wallet 232 to interact with the digital wallet 232 (e.g., perform balance inquiries, convert tokens, access exchanges and/or marketplaces, perform transactions, access computing systems, and/or the like). In some embodiments, the user can access an expanded feature set, via the input/output circuit 254b of the host device 234, when the digital wallet 232 is docked to the host device 234. For example, host device 234 can include computer-executable code structured to securely access data from the digital wallet 232 of the digital wallet 232 and to perform operations using the data. The data can include authentication information, configuration information, asset keys, and/or token management instructions. The data can be used by an application that executes on or by the host device 234. The data can be used to construct application programming interface (API) calls to other applications that require or use the data provided by digital wallet 232. Other applications can include any on-chain or off-chain computer applications, such as dApps (e.g., decentralized lending applications, decentralized cryptocurrency exchanges, decentralized NFT marketplaces, decentralized gaming platforms, decentralized social media platforms, decentralized music streaming platforms), third-party computing systems (e.g., financial institution computing systems, social networking sites, gaming systems, online marketplaces), and/or the like.

The secure memory 238 is shown to include an authentication circuit 240 and a digital asset management circuit 246. The authentication circuit 240 and/or digital asset management circuit 246 include computer-executable code that, when executed by one or more processors, such as one or more processors 256a and/or 256b, performs specialized computer-executable operations. For example, the authentication circuit 240 can be structured to cause the digital wallet 232 to establish, maintain and manage a secure electronic connection with another computing device, such as the host device 234. The digital asset management circuit 246 can be structured to cause the digital wallet 232 to allow a user to manage the digital assets accessible via the digital wallet 232. In some embodiments, the authentication circuit 240 and the digital asset management circuit 246 are combined in whole or in part.

As shown, the authentication circuit 240 can include retrievably stored security, authentication, and/or authorization data, such as the authentication key 242. The authentication key 242 can be a numerical, alphabetic, or alphanumeric value or combination of values. The authentication key 242 can serve as a security token that enables access to one or more computing systems, such as the host device 234. For instance, in some embodiments, when the digital wallet 232 is paired or docked to (e.g., establishes an electronic connection with) the host device 234, the user may be prompted to enter authentication information via the input output circuit(s) 254a and/or 254b. The authentication information may include a PIN, a password, a pass phrase, biometric information (e.g., fingerprint, a set of facial features, a retinal scan), a voice command, and/or the like. The authentication circuit 240 can compare the user-entered information to the authentication key 242 and maintain the electronic connection if the items match at least in part.

As shown, the authentication circuit 240 can include retrievably stored configuration information 244. The configuration information 244 can include a numerical, alphabetic, or alphanumeric value or combination of values. These items can be used to enable enhanced authentication protocols. For instance, the configuration information 244 can include a timeout value for an authorized connection between the digital wallet 232 and the host device 234. The configuration information 244 can also include computer-executable code. In some embodiments, for example, where a particular digital wallet 232 is set up to pair with only one or a small number of pre-authorized host devices 234, the configuration information 244 can include a device identifier and/or other device authentication information, and the computer-executable code may be structured to verify the device identifier and/or other device authentication information against the information associated with or provided by the host device 234. When a pairing is attempted, the computer-executable code may initiate or cause the host device 234 to initiate an electronic communication (e.g., an email message, a text message) using user contact information stored as configuration information 244.

As shown, the digital asset management circuit 246 can include retrievably stored digital asset data, such as the asset key 248. The asset key 248 can be a numerical, alphabetic, or alphanumeric value or combination of values. In some embodiments, the asset key 248 is a private key in a public/private key pair, a portion thereof, or an item from which the private key can be derived. Accordingly, the asset key 248 proves ownership of a particular digital asset stored on a blockchain system 100. The asset key 248 can allow a user to perform blockchain transactions involving the digital asset. The blockchain transactions can include computer-based operations to earn, lend, borrow, long/short, earn interest, save, buy insurance, invest in securities, invest in stocks, invest in funds, send and receive monetary value, trade value on decentralized exchanges, invest and buy assets, sell assets, and/or the like. The digital wallet 232 can be identified as a party to a blockchain transaction on the blockchain system 100 using a unique cryptographically generated address (e.g., the public key in the public/private key pair).

As shown, the digital asset management circuit 246 can also include retrievably stored asset management instructions 250. The asset management instructions 250 can include a numerical, alphabetic, or alphanumeric value or combination of values. These items can be used to enable computer-based operations related to managing digital assets identified by the asset keys 248. For instance, the asset management instructions 250 can include parameter values, metadata, and/or similar values associated with various tokens identified by the asset keys 248 and/or by the blockchain systems 100 associated with particular tokens. The asset management instructions 250 can also include computer-executable code. In some embodiments, for example, asset management functionality (e.g., balance inquiry and the like) can be executable directly from the digital wallet 232 rather than or in addition to being executable from the host device 234.

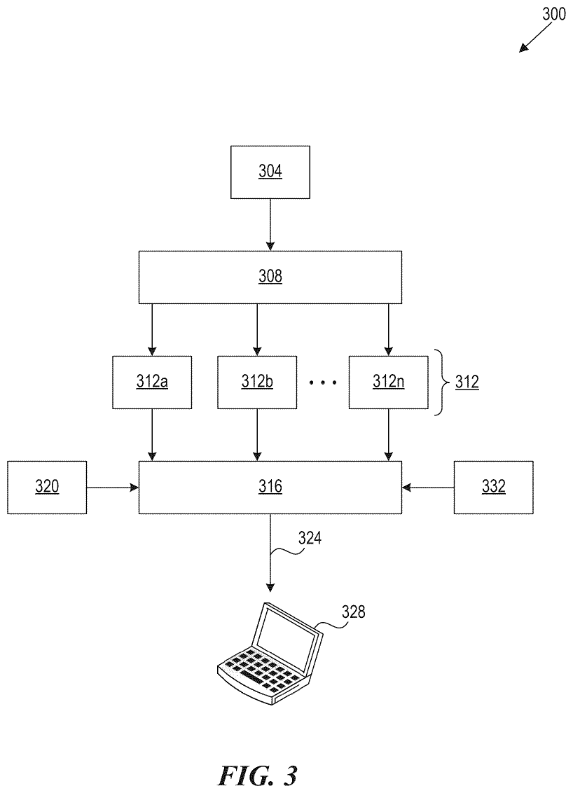

FIG. 3 is a block diagram illustrating an example machine learning (ML) system 300. The ML system 300 is implemented using components of the example computer system 900 illustrated and described in more detail with reference to FIG. 9. For example, the ML system 300 can be implemented on the computer system 900 using instructions 08 programmed in the main memory 906 illustrated and described in more detail with reference to FIG. 9. Likewise, embodiments of the ML system 300 can include different and/or additional components or be connected in different ways. The ML system 300 is sometimes referred to as a ML module.

The ML system 300 includes a feature extraction module 308 implemented using components of the example computer system 900 illustrated and described in more detail with reference to FIG. 9. In some embodiments, the feature extraction module 308 extracts a feature vector 312 from input data 304. Input data 304 can include ticket and/or traveler information. The feature vector 312 includes features 312a, 312b, . . . , 312n. The feature extraction module 308 reduces the redundancy in the input data 04, e.g., repetitive data values, to transform the input data 304 into the reduced set of features 312, e.g., features 312a, 312b, . . . 312n. The feature vector 312 contains the relevant information from the input data 304, such that events or data value thresholds of interest can be identified by the ML model 316 by using this reduced representation. In some example embodiments, the following dimensionality reduction techniques are used by the feature extraction module 308: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In some embodiments, the ML model 316 performs deep learning (also known as deep structured learning or hierarchical learning) directly on the input data 304 to learn data representations, as opposed to using task-specific algorithms. In deep learning, no explicit feature extraction is performed; the features 312 are implicitly extracted by the ML system 300. For example, the ML model 316 can use a cascade of multiple layers of nonlinear processing units for implicit feature extraction and transformation. Each successive layer uses the output from the previous layer as input. The ML model 316 can thus learn in supervised (e.g., classification) and/or unsupervised (e.g., pattern analysis) modes. The ML model 316 can learn multiple levels of representations that correspond to different levels of abstraction, wherein the different levels form a hierarchy of concepts. In this manner, the ML model 316 can be configured to differentiate features of interest from background features.

In one example, the ML model 316, e.g., in the form of a CNN generates the output 324, without the need for feature extraction, directly from the input data 304. In some examples, the output 324 is provided to the computer device 328 or video display 418. The computer device 328 is a server, computer, tablet, smartphone, smart speaker, etc., implemented using components of the example computer system 900 illustrated and described in more detail with reference to FIG. 9. In some embodiments, the steps performed by the ML system 300 are stored in memory on the computer device 328 for execution.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field can be approximated mathematically by a convolution operation. CNNs are based on biological processes and are variations of multilayer perceptrons designed to use minimal amounts of preprocessing.

The ML model 316 can be a CNN that includes both convolutional layers and max pooling layers. The architecture of the ML model 316 can be “fully convolutional,” which means that variable sized sensor data vectors can be fed into it. For all convolutional layers, the ML model 316 can specify a kernel size, a stride of the convolution, and an amount of zero padding applied to the input of that layer. For the pooling layers, the model 216 can specify the kernel size and stride of the pooling.

In some embodiments, the ML system 300 trains the ML model 316, based on the training data 320, to correlate the feature vector 312 to expected outputs in the training data 320. Training data 320 can include traveler data and airline or flight data. As part of the training of the ML model 316, the ML system 300 forms a training set of features and training labels by identifying a positive training set of features that have been determined to have a desired property in question, and, in some embodiments, forms a negative training set of features that lack the property in question.

The ML system 300 applies ML techniques to train the ML model 316, that when applied to the feature vector 312, outputs indications of whether the feature vector 312 has an associated desired property or properties, such as a probability that the feature vector 312 has a particular Boolean property, or an estimated value of a scalar property. The ML system 300 can further apply dimensionality reduction (e.g., via linear discriminant analysis (LDA), PCA, or the like) to reduce the amount of data in the feature vector 312 to a smaller, more representative set of data.

The ML system 300 can use supervised ML to train the ML model 316, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 332 is formed of additional features, other than those in the training data 320, which have already been determined to have or to lack the property in question. The ML system 300 applies the trained ML model 316 to the features of the validation set 332 to quantify the accuracy of the ML model 316. Common metrics applied in accuracy measurement include: Precision and Recall, where Precision refers to a number of results the ML model 316 correctly predicted out of the total it predicted, and Recall is a number of results the ML model 316 correctly predicted out of the total number of features that had the desired property in question. In some embodiments, the ML system 300 iteratively re-trains the ML model 316 until the occurrence of a stopping condition, such as the accuracy measurement indication that the ML model 316 is sufficiently accurate, or a number of training rounds having taken place. The validation set 332 can include data corresponding to traveler data or airline or flight data, for example, or combinations thereof. This allows the detected values to be validated using the validation set 332. The validation set 332 can be generated based on analysis to be performed.

In some embodiments, ML system 300 is a generative artificial intelligence or generative AI system capable of generating text, images, or other media in response to prompts. Generative AI systems use generative models such as large language models to produce data based on the training data set that was used to create them.

### Proof of Inventory Blockchain Consensus Protocol

The disclosed proof of inventory system leverages the capabilities of blockchain technology for the travel industry. The proof of inventory system enables airlines and travel suppliers to tokenize inventories as, for example, NFTs, which facilitates access to the inventory and enables expanded offerings to customers. As such, airlines connect through blockchain-based distribution channels to reach additional customer segments. A proof of inventory blockchain consensus protocol enables airlines and travel suppliers to transform a product inventory into NFTs that each represent a unique (e.g., non-fungible) asset of the inventory. Users can own the NFTs, which provide a multitude of capabilities including the ability to cancel, sell, transfer, resell, or auction the NFTs and underlying non-fungible assets. Moreover, NFT owners can receive offers for their NFTs or other related products, which fosters a dynamic marketplace.

In one example, the proof of inventory blockchain consensus protocol enables the representation of each record locator (RL) of an airline or travel supplier's product inventory as NFTs that are linked to the underlying travel service assets. In this context, an NFT serves as a non-fungible asset that represents either an airline RL or a specific travel product. As used herein, a “record locator (RL)” refers to an alphanumeric or alpha code employed to identify and access a particular record within an airline's traditional reservation system. An airline can use an RL to identify each travel service product, which typically appears on the itinerary provided to a passenger. The RL can be described as, relate to, or include a confirmation number, reservation number, confirmation code, booking reference, booking code, vendor locator, city of origin and destination, airport of origin and destination, departure and arrival times, stopovers, seat, class, type of aircraft, aircraft identification number, and other description. The reservation system generates a unique RL whenever a customer makes a reservation or booking, commonly referred to as an itinerary. When the itinerary is entered into the reservation system, it becomes a passenger name record (PNR). Notably, itineraries can be entered into the system by passengers, travel agents, or airline personnel. Examples of RLs include RMT33W, KZVGX5, and IIRCYC.

The RL includes comprehensive information about an itinerary, such as dates, origin and destination airports, aircraft details, rates, and taxes, among other relevant data. When a customer purchases an airline ticket, the customer must select a specific itinerary, choose an appropriate price, provide personal information, and complete the payment process. Upon confirmation of the payment, the reservation system automatically generates the PNR, associating the airline product (e.g., the ticket) with the specific customer within the itinerary.

The NFTs are created by integrating airline reservation systems with the blockchain network. This integration ensures that the NFTs are directly linked to the underlying travel service product (e.g., ticket data) including flight details, passenger information, pricing, and other relevant data. The integration process involves the transformation of the unique (e.g., non-fungible) RL associated with each ticket into a corresponding NFT. The RL serves as a unique identifier and is used to access and verify the ticket data on the blockchain.

The PNR contains information concerning the passenger and the associated itinerary, including name, itinerary details, contact information, flight ticket number, reservation number, office or agency details, and historical data, among other relevant elements. Through a configured protocol, the PNR undergoes a transformation process to generate an NFT. This transformation allows for the option of modifying passenger information, including the associated name, up to a preset threshold “flight deadline,” which can occur within 48 hours before the flight date, for example. Given the PNR now represented by an NFT, it inherits all the properties typically associated with any NFT. Consequently, the NFT integrates the PNR, ticket number, and a hash number (also referred to as a “hash value” or “hash”). As used herein, a “hash” can refer to the outcome of a hash function, a cryptographic operation that generates unique and irreproducible identifiers based on specific information. These hash functions primarily serve to encode data, resulting in a single-character string. They also have a role in ensuring data authenticity, securely storing passwords, and signing electronic documents.

In one example, the NFTs are generated is association with smart contracts on the blockchain, embedding the ticket information within the contract code. The smart contracts contain the necessary terms and conditions, including restrictions, refund policies, and transferability rules, as set by the airline. These contracts are immutable and enforceable, ensuring that the NFTs comply with the airline's requirements and provide a secure representation of the ticket.

Cryptographic mechanisms are employed to establish a link between the NFT and the underlying ticket. A cryptographic hash function is applied to the ticket data, generating a unique and unalterable identifier. This hash is then stored with the NFT, serving as a cryptographic proof of the ticket's authenticity and integrity. Any modifications or tampering with the ticket data would result in a mismatch with the stored hash, providing a verifiable indicator of potential fraud or unauthorized alterations.

The personal data contained within the PNR, which is now linked to the NFT, can be added, modified, or omitted by the owner of the NFT. Similarly, an airline retains the ability to modify the itinerary or ticket number, thereby influencing the information reflected in the NFT. However, the hash number remains immutable and impervious to alteration or tampering due to the inherent capabilities of blockchain technology. Consequently, the hash number guarantees the authenticity and certainty that the NFT consistently represents the same underlying product.

The proof of inventory consensus protocol operates on the principle that if a PNR exists, the corresponding NFT representing the PNR will also exist as a tokenized representation with all the characteristics associated with any NFT. NFT holders can exercise various rights and actions, such as transferring, selling, reselling, receiving offers, or even auctioning their NFTs, all of which encompass the travel information encapsulated within. These NFTs can be traded on online marketplaces, facilitating seamless transfers and sales, subject to the predefined threshold deadline set before the date of travel or ticket execution.

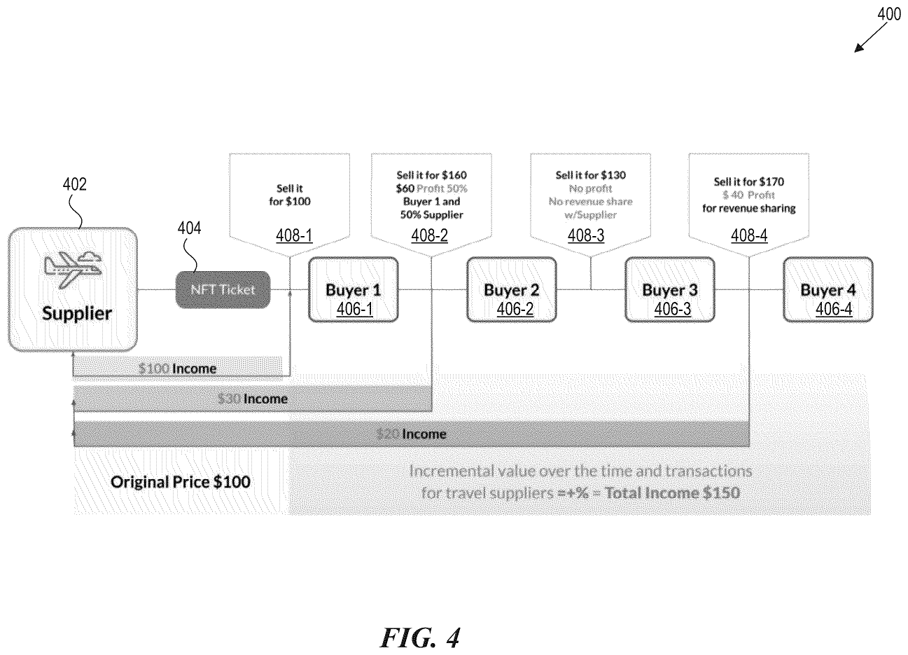

FIG. 4 illustrates a process 400 including smart contracts configured to allocate NFTs that represent travel service products. As shown, smart contracts enable an allocation and revenue share model between users (e.g., consumers, suppliers) of a travel system. An NFT representation of an airline ticket is obtained from a supplier 402. The NFT ticket 404 is exchanged through a sequence of multiple buyers 406 at different time for different values 408. The reallocation of the NFT ticket 404 can gain/lose value for the current NFT holder as the value of the underlying product changes. The final buyer 406-4 can then redeem the NFT ticket 404 for the underlying airline ticket.

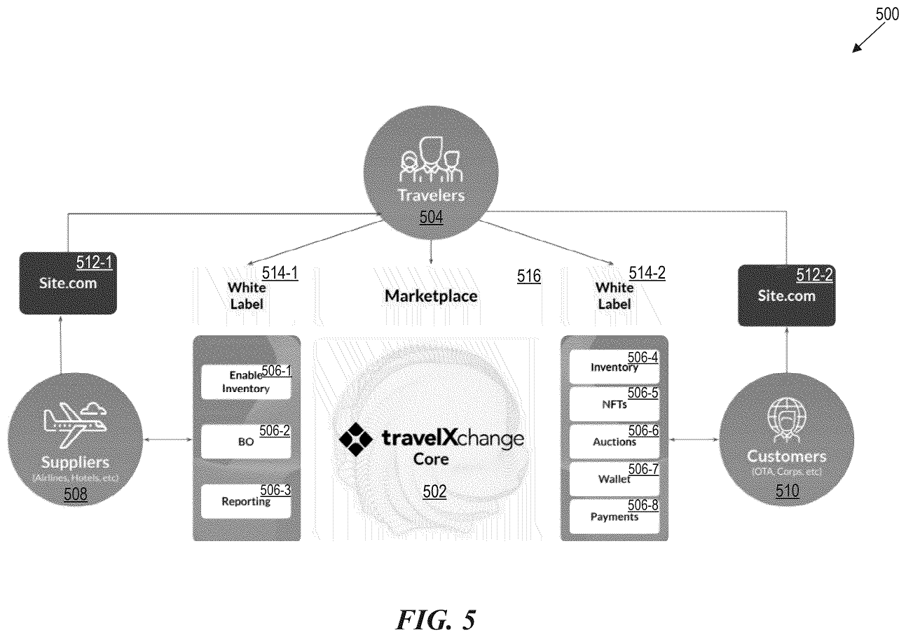

FIG. 5 illustrates components of a system 500 for exchanging non-fungible digital assets (e.g., NFTs) linked to travel service products. As shown, a platform 502 provides travelers 504 with services 506 for suppliers 508 and customers 510 through a white label component 514 of the platform 502 that offers a marketplace 516 for the travelers 504. For the suppliers 508, the services include enabling inventory 506-1, BO 506-2 (e.g., business operations), and reporting 506-3. For the customers 510, services include inventory 506-4, NFTs 506-5, auctions 506-6, wallets 506-7, and payments 506-8. The travelers 504 can also access the suppliers 508 and customers 510 through their respective websites 512.

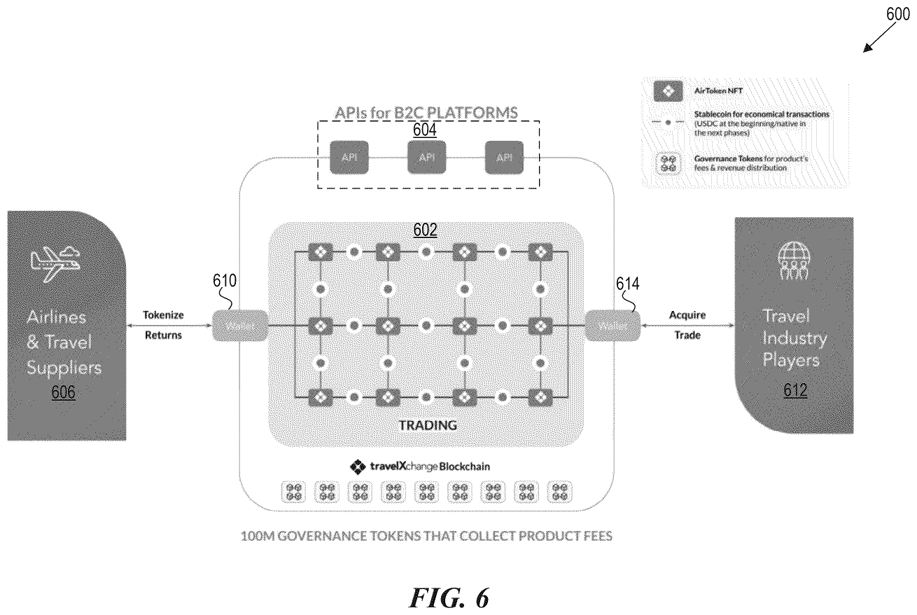

FIG. 6 illustrates a system 600 including a blockchain-based exchange 602 of non-fungible digital assets (“AirToken NFTs”) that represent travel service products. As shown, the blockchain 602 can be accessed through APIs 604 for business-to-customer platforms. The blockchain 602 enables secure exchanges (e.g., allocation, reallocation) of digital assets. Airlines and travel suppliers 606 can tokenize products (e.g., travel assets) that are stored in respective digital wallets 610. Travel industry participants 612 can acquire and trade NFTs stored in respective wallets 614. As shown, the blockchain 602 includes a network of AirToken NFTs, stable coins for transactions, and governance tokens for fees and revenue distribution.

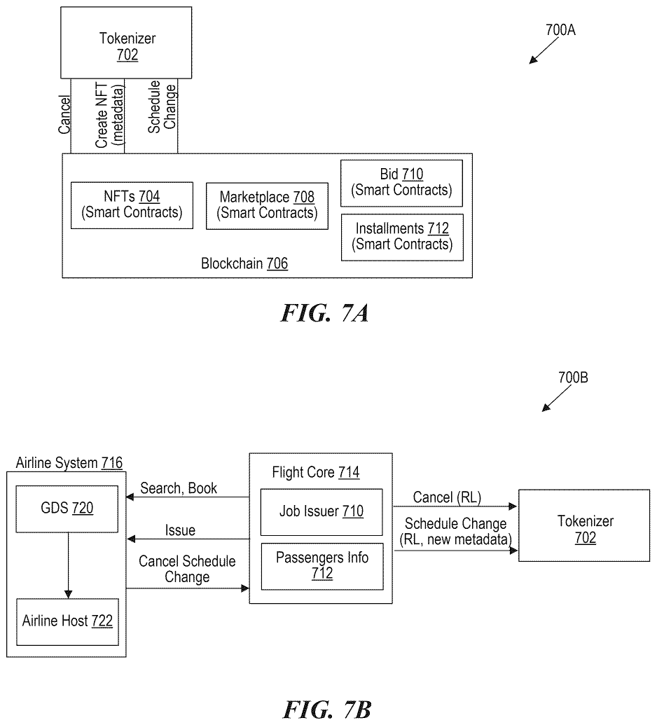

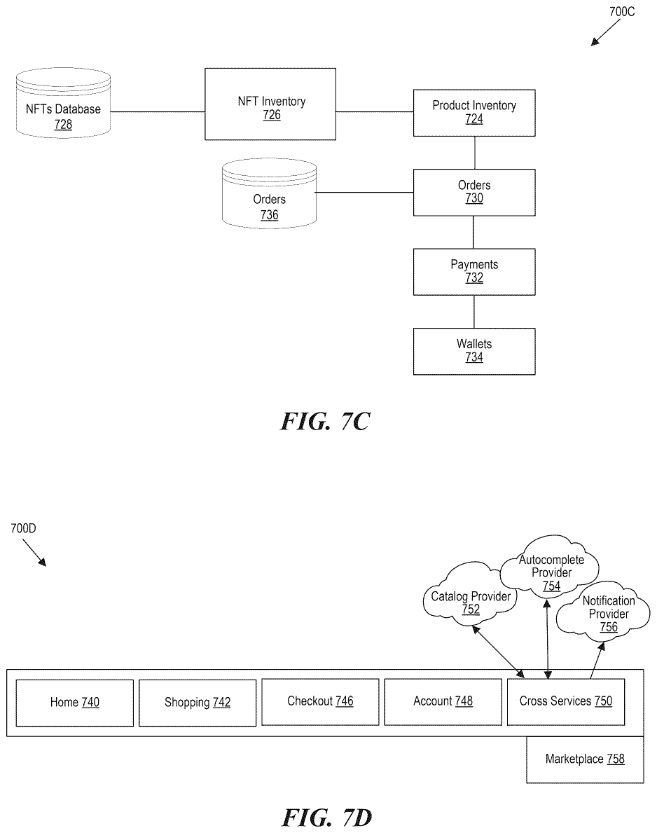

FIG. 7A illustrates functional components 700A for a proof of inventory blockchain consensus protocol. The components include a tokenizer 702 that generates and stores NFTs 704 on the blockchain 706 and/or a database (not shown). The blockchain 706 includes an online marketplace 708 and is enabled for bids 710 and installments 712. The features of the blockchain are based on smart contracts.

### APIs in Blockchain-Based Infrastructure for Travel Service Products

One or more APIs in the blockchain-based infrastructure for the travel industry allows airlines, travel suppliers, and developers to connect their inventory with an intermediary infrastructure that provides access to offering travel assets as non-fungible digital assets. For example, FIG. 6 shows the blockchain 602 that is accessed through the APIs 604. Utilizing the blockchain to facilitate communication for APIs allows for decentralized and authoritative methodologies of securing transaction histories. In other words, a network of devices running a secure blockchain implementation could form a federated network of trusted devices that tracks and manages these relationships over time in a way that does not require a centralized authentication authority or tracking systems.

The API blockchain-based infrastructure allows airlines and travel suppliers to link their product inventory automatically and in a decentralized manner to use the infrastructure as their own, thereby creating a platform as their own marketplaces. The API blockchain-based infrastructure for the travel industry includes a set of requirements that allow the exchange of data in a decentralized way with airlines and travel suppliers. In one example, an API Representational State Transfer (REST) includes a set of restrictions used so that HTTP requests comply with the guidelines defined in the local architecture.

Examples of services accessible via the APIs include Get NFTs resale inventory, Add NFT for sale, Remove NFT from sale, Buy NFT, and Make Payments as follows:
Get NFTs resale inventory: obtains all information on the database of all NFTs that are offered for sale.
Add NFT for sale: enables when a user buys an NFT. The user can decide to offer the NFT for sale at a fixed price, receive offers or hold an auction up to threshold time (e.g., 48 hours) before the flight deadline.
Remove NFT for sale: enables when a user bought an NFT and does not want to offer the NFT for sale or put it up for sale and decides to remove it from being offered.
Buy NFT: enables an ability to buy an NFT with all the metadata and store it in a virtual wallet.
Make payments: airlines and travel suppliers are allowed to sell their travel products through the API by accepting payments in various cryptocurrencies or digital assets (e.g., USDC, BTC, ETH) and traditional payment methods.

With these services, any airline, travel supplier or developer can use the infrastructure and build on top of it their own platform to offer travel products as NFTs.

FIG. 7B illustrates an API blockchain-based infrastructure 700B including functional components of an API for non-fungible digital assets for travel service products. As shown, APIs enable communications between a tokenizer 702, flight core 714, and airline system 716. The flight core 714 has components including a job issuer 718 and passengers information 720. The flight core 714 can communicate messages or signals to the tokenizer 702 to cancel and schedule changes of RLs. The flight core 714 can also send messages or signals to the airline system 716 to search and book flights and issue tickets. The airline system 716 can send messages or signals to the flight core 714 to cancel schedule changes. The airline system 716 includes a GDS 720 that can communicate with an airline host 722 to perform the aforementioned actions.

### Tokenization and Smart Contracts for Travel Service Products

The disclosed technology enables frictionless transfer, resale, or commercialization of a flight ticket that has been assigned to a user, which improves over the outdated processes and technology of the travel industry. The disclosed technology can enable cancelling or modifying flight reservations (e.g., flight ticket) using a blockchain-based infrastructure. By using blockchain technologies, travel industry suppliers can tokenize products. Specifically, non-fungible digital assets such as NFTs give the ability to assign or claim ownership of any unique piece of digital data, trackable by using blockchain technology as a public ledger. The technology can be adapted to other industries such as cloud computing, gaming, fintech, e-commerce, art, etc.

An NFT is minted as a digital object that represents a physical asset. The process for doing so is referred to herein as tokenization. In one example, an NFT can represent an airline's RL of an airline ticket and accompanying metadata. The tokenization thus generates an NFT that represents the ticket. In one implementation, the platform uses blockchain technology to tokenize airline tickets and other travel service products, transforming each product into an NFT having the capability of being a traceable, unique, and unrepeatable piece of data that is capable of transfer as often as owners choose. In addition, accompanying smart contracts can have functionalities to manage operations of the NFT. Examples of the functionalities include reprogramming and cancelation services and conditions of the ticket or travel product associated with the NFT.

In general, travel service products can be tokenized and stored on a blockchain (e.g., on one or more database). Smart contracts can be used to transact with the tokenized assets, which can be associated with a series of metadata that guarantees authenticity, identifies ownership, a starting and acquisition value and all transactions that have occurred since creation. The metadata can indicate who created the asset, who has tokenized the asset, and where and for how much it has been sold/purchased. By tokenizing content, a digital certificate of ownership and authenticity is created, which indicates that the content is unique and that the property rights are held by the person who has acquired it (e.g., the owner). In this sense, the smart contracts of the NFTs can serve different purposes, for example, ensuring for the creator of the NFT, in this case the airlines or travel suppliers, receive benefits produced by a future resale.

In one example, the technology tokenizes and transforms each RL (or generally a travel service product) obtained from a travel supplier into an NFT. The technology thus allows for selling travel assets as NFTs, to new distribution channels and customers. The airline companies can tokenize and sell their inventory as one or more NFTs in advance up to, for example, 36 months, unlike limitations of only up to 11 months. A smart contract can manage the metadata and properties of the NFT, which is the representation of an airline ticket, giving the possibility to receive offers, sell, auction and transfer the ownership of the underlying travel product to another user as many times as decided until a threshold flight deadline (e.g., the day of the flight).

An implementation is represented in the following example: FlightX airline tokenizes all its flight inventory and offers it on a digital platform. The RL associated with a New York to/from London round trip for Jul. 30, 2024 ticket has the alphanumeric code ABC123. An NFT for this flight segment has a hash of AB12Hh38NJ76SsYt608M. The airline offers this NFT in its digital marketplace and user-1 decides to buy it. User-1 is now the owner-1 of that NFT. Owner-1 decides to receive offers for his ticket and user-2 offers 20% more than the amount paid by owner-1. Owner-1 accepts the offer from user-2 and that user becomes the new owner of the NFT (i.e., user-2 becomes owner-2). Owner-2 decides to open an auction for his NFT. The auction value exceeds 30% the amount that owner-2 previously paid, so he decides to close the auction and transfers the ownership to the winner user-3, who is now owner-3. Owner-3 decides to keep the NFT and not receive offers or open an auction, but 15 days before the flight deadline, he cannot travel and decides to give it to a friend, and now his friend, user-4, is the new owner of the NFT. Owner-4 decides to use the NFT and keeps it until the flight deadline. For example, 48 hours before the flight, the metadata from the owner-4 NFT becomes the final metadata for the airline ticket to be used. Finally, Owner-4 is the passenger who uses the FlightX air ticket.

FIG. 7C illustrates functional components 700C of a system that tokenizes travel products to enable resale, transfer, and trading of the travel products in a virtual space. As shown, a product inventory 724 is converted to an NFT inventory 726 that is stored at an NFT database 728 (e.g., blockchain). The orders 730, payments 732, and wallets 734 can be operated with smart contracts. The orders can be stored in an orders database 736.

### Digital Asset Allocation System for Travel Service Products

The disclosed technology includes a type or standardized NFT for the air travel industry, to provide a white label NFT marketplace that is partly or entirely customizable by a supplier or a developer. The white label NFT exchange platform works like an NFT exchange platform where extra features can be added per an intermediary's requirements. The NFT exchange platform allows users to sign-up, create an account, create their own wallet, set up all preferences and transfer fiat money or cryptocurrency into their respective accounts. When a user creates an account, the user enters a personal portal where the user will find all the necessary information about the user's NFTs such as owner information, hash identification, transaction history, price history, and any relevant information.

The users of the NFT exchange platform can search by filters such as destination, date, airline, stopovers, payment methods, offers, bids, and auctions. When a user purchases an NFT, smart contracts are executed to ensure that the terms and conditions between the buyer and seller are satisfied and the NFT is then transferred from the seller's wallet to the buyer's wallet. The user who was allocated the NFT can configure whether they want to sell the NFT at a fixed price, open for bidding or even start an auction with a time limit and a base price. When another user accepts the offer, the NFT is transferred to the buyer's wallet and the buyer can reconfigure the conditions. The NFT can be reallocated as many times as the user decides. In one example, the NFT can be transferred or reallocated as many times as the users decide, up to a threshold time limit (e.g., 48 hours) before the date of travel or execution of the ticket, or up to a threshold set by a supplier of the travel service product. Moreover, before the threshold time limit, the NFT is fixed/burned and is rendered as an air ticket with the passenger's name or other identifying information of the last NFT holder.

FIG. 7D illustrates functional components of a platform 700D for exchanging (e.g., re/allocating) non-fungible digital assets that are linked to travel related products. The platform 700D includes functions for a home 740, shopping 742, checkout 746, participant accounts 748, and cross services 750. Examples of the cross services 750 include a catalog provider 752, autocomplete provider 754, and notification provider 756. The platform hosts a marketplace 758 for users.

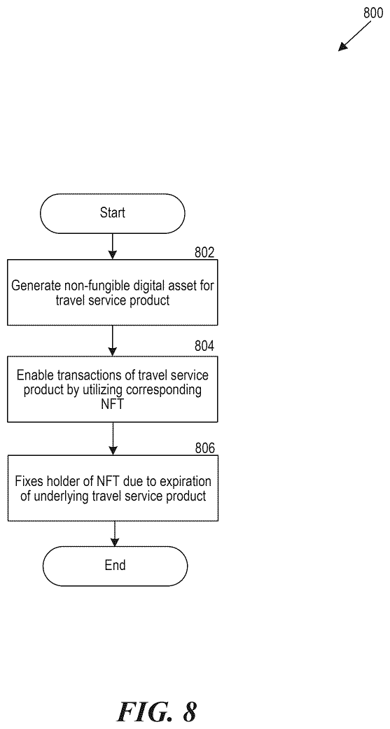

FIG. 8 is a flowchart that illustrates processes 800 performed by a blockchain-based platform for exchanging travel service products. The processes 800 can be performed by a blockchain-based platform that is integrated into legacy travel service systems. In one example, a system that administers the platform includes a processor and a non-transitory memory storing instructions that, when executed by the processor will cause the system to perform the processes 800.

At 802, the system generates a non-fungible digital asset (e.g., NFT) based on a code (e.g., RL) associated with a travel service product (e.g., flight ticket) from an inventory of travel service products. The code is obtained from a legacy travel service database and is associated with user information (e.g., PNR). The corresponding NFT is likewise associated with the user information. The system can store the NFT at a blockchain (e.g., database(s)). The code stored in the travel service database coexists with the linked NFT stored at the blockchain.

In one example, the system transforms an inventory of travel service products stored in a legacy database into an inventory of respective NFTs that are stored in other database(s). In particular, the system transforms a PNR into the NFT that integrates properties of the PNR and an immutable hash value. The PNR information can include a passenger name, contact information, flight ticket number, and reservation number, which is modifiable up to a threshold minimum time before departure of the flight associated with the flight ticket number.

An NFT can be generated in association with a smart contract implementing rules that restrict transactions for the NFT, where the rules are set by a supplier of the travel service product. The system can execute the smart contract, where executing the smart contract causes transferring, selling, or buying of the NFT in accordance with the rules. As such, ownership of the NFT and underlying travel service product changes based on the execution of the smart contract.

At 804, the system enables one or more transactions via one or more APIs for the NFT including altering the PNR information of the associated travel service product. The system can perform successive transactions including, for example, transfers of the NFT through one or more additional users to a current user. In one example, the system authorizes access to the NFT blockchain by virtue of being suppliers of the inventory of travel service products. Further, consumers of the travel service products are authorized to perform transactions with corresponding NFTs. Examples of the transactions include to cancel, transfer, resell, or auction NFTs. In one example, in response to occurrence of a transaction, the system updates metadata associated with a particular travel service product synchronously or asynchronously at both the travel service database and the blockchain. When transferring, the system can add, modify, or omit PNR information associated with a travel service product. As such, transforming the modified PNR to the NFT integrates properties of the PNR, which can be modified with successive transactions of the NFT. However, the hash value of the NFT remains immutable despite the transactions.

In one example, the system communicates an offer to a current owner of the NFT to perform a transaction for a travel service product and, in response to acceptance of the offer, performs the transaction with the NFT. Doing so causes a corresponding transaction with the travel service product. For example, the system can notify a current owner of an offer to sell a flight ticket. In response to an indication of acceptance of the offer, the system can perform the transaction by selling the corresponding NFT, which results in a corresponding transaction with the travel service product.

At 806, the system detects expiration for utilizing the travel service product (e.g., 48 hours before a flight) and prevents further transactions with the NFT. The system thus changes the association of the code from the prior user to the final user, which can redeem the travel service product (e.g., becomes the flight passenger).

### Computer System

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 900 can perform operations in real time, in near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A blockchain-based method for proof of inventory, the method comprising:
generating a non-fungible digital asset based on a code that represents a travel service product in an inventory of travel service products that are each non-fungible,
wherein the code is stored in a travel service database in association with a user information of an first user,
wherein the non-fungible digital asset is associated with the user information;
storing the non-fungible digital asset at a blockchain,
wherein the code stored in the travel service database coexists linked with the non-fungible digital asset stored at the blockchain;
successively performing transactions with the non-fungible digital asset through one or more additional users to a final user of the non-fungible digital asset;
detecting expiration for utilizing the travel service product; and
in response to detecting the expiration for utilizing the travel service product, fixing the association of the code with the final user of the one or more additional users and preventing further transactions with the non-fungible digital asset.

2. The method of claim 1, wherein the travel service product is a flight ticket and wherein the non-fungible digital asset is a non-fungible token (NFT).

3. The method of claim 1 further comprising:
transforming the inventory of travel service products into an inventory of respective non-fungible tokens (NFTs),
wherein the inventory of NFTs is stored in the blockchain that is separate and distinct from the travel service database.

4. The method of claim 3 further comprising:
authorizing access to the blockchain by virtue of being suppliers of the inventory of travel service products; and
authorizing consumers of the travel service products to perform transactions for underlying travel service products based on respective NFTs,
wherein the transactions include to cancel, transfer, resell, or auction of the NFTs.

5. The method of claim 3 further comprising:
in response to occurrence of a transaction associated with a particular travel service product or corresponding NFT, updating metadata associated with a particular travel service product synchronously or asynchronously at both the travel service database and the NFT database.

6. The method of claim 1, wherein the non-fungible digital asset is a non-fungible token (NFT), and wherein the method further comprises:
communicating an offer to a current owner of the NFT to perform a transaction for the travel service product; and
in response to acceptance of the offer, perform the transaction with the NFT thereby causing a corresponding transaction with the travel service product.

7. The method of claim 1, wherein the code that represents the travel service product includes a record locator (RL) associated with a passenger name record (PNR) information stored at a reservation system of a travel service supplier, and wherein generating the non-fungible digital asset comprises:
transforming the PNR into the non-fungible digital asset that integrates properties of the PNR and a hash value,
wherein the PNR information includes a passenger name, contact information, flight ticket number, and reservation number, and
wherein the PNR information is modifiable up to a threshold minimum time before a flight associated with the flight ticket number.

8. The method of claim 1, wherein generating the non-fungible digital asset comprises:
adding, modifying, or omitting passenger name record (PNR) information associated with the travel service product; and
transforming the modified PNR to the non-fungible digital asset,
wherein the non-fungible digital asset integrates properties of the PNR and includes an immutable hash value.

9. The method of claim 1, wherein one or more reservations systems are integrated with a blockchain network such that NFTs are directly linked to corresponding travel service products, wherein the code that represents the travel service product includes a record locator (RL) associated with passenger name record (PNR) information, and wherein generating the non-fungible digital asset comprises:
generating the non-fungible digital asset as an NFT in association with a smart contract stored on the blockchain,
wherein the smart contract implements rules that restrict transactions for the NFT, and
wherein the rules of the smart contract are set by a supplier of the travel service product.

10. A blockchain-based system for travel service products, the system comprising:
at least one hardware processor; and
at least one non-transitory memory storing instructions, which, when executed by the at least one hardware processor, cause the system to:
generate a non-fungible digital asset based on passenger name record (PNR) information associated with a travel service product,
wherein the non-fungible digital asset includes an immutable hash value; and
enable one or more transactions via one or more application programming interfaces (APIs) for the non-fungible digital asset including altering the PNR information of the associated travel service product,
wherein the travel service product is stored at a reservations database and the non-fungible digital asset is stored at a digital assets database, and
wherein the one or more transactions enabled by the APIs include allocating, reallocating, or processing payments for the non-fungible digital asset; and
update the digital assets database and the reservations database to reflect modification of the PNR information of the non-fungible digital asset and corresponding travel service product.

11. The blockchain-based system of claim 10, wherein the travel service product includes an airline ticket, and wherein the non-fungible digital asset is a non-fungible token (NFT) including a hash value.

12. The blockchain-based system of claim 11, wherein to generate the NFT comprises causing the system to:
generate the NFT in association with a smart contract that implements rules set by a supplier of the travel service product.

13. The blockchain-based system of claim 11 further caused to:
perform a transaction that modifies the PNR information associated with the travel service product; and
update the NFT to reflect the modified PNR information but without modifying the hash value.

14. The blockchain-based system of claim 11:
wherein the travel service product is a flight ticket, and
wherein the PNR information of the flight ticket and corresponding NFT is modifiable up to a threshold minimum time before a flight of the flight ticket is scheduled to occur.

15. A non-transitory, computer-readable storage medium comprising instructions recorded thereon, wherein the instructions when executed by at least one data processor of a system, cause the system to:
generate a non-fungible digital asset based on a travel service product;
execute a smart contract for the travel service product based on the non-fungible digital asset,
wherein executing the smart contract causes transferring, selling, or buying of the non-fungible digital asset; and
change ownership of the travel service product underlying the non-fungible digital asset based on the execution of the smart contract.

16. The non-transitory, computer-readable storage medium of claim 15, wherein the system is further caused to:
notify a current owner of the travel service product of an offer to perform a transaction with the non-fungible digital asset; and
in response to an indication of acceptance of the offer, perform the transaction with the non-fungible digital asset and cause a corresponding transaction with the travel service product.

17. A blockchain-based platform for air travel products, the platform comprising:
at least one hardware processor; and
at least one non-transitory memory storing instructions, which, when executed by the at least one hardware processor, cause the platform to:
generate a non-fungible digital asset based on a travel service product;
store the non-fungible digital asset in a blockchain;
allocate the non-fungible digital asset in the blockchain to a first user; and
reallocate the non-fungible digital asset in the blockchain to a second user such that ownership of the travel service product underlying the non-fungible digital asset is transferred from the first user to the second user.

18. The blockchain-based platform of claim 17, wherein the travel service product is an airline ticket and wherein the non-fungible digital asset is a non-fungible token (NFT).

19. The blockchain-based platform of claim 18 further caused to:
transform an inventory of travel service products stored at a reservations database into an inventory of respective NFTs stored at a blockchain.

20. The blockchain-based platform of claim 19 further caused to:
authorize access to the blockchain-based platform by virtue of being suppliers of the inventory of travel service products; and
authorize consumers of the travel service products to perform transactions on the blockchain-based platform for the travel service products.
